(19) United States
(12) Patent Application Publication
(10) Pub. No.: US 2014/0099456 A1
(43) Pub. Date: Apr. 10, 2014

(54) FIBER REINFORCED POLYMER STRENGTHENING SYSTEM

(71) Applicants: Venkatkrishna Raghavendran, Greer, SC (US); Bernhard Zeiler, Moore, SC (US); Qi Liao, Ann Arbor, MI (US); Jeffrey Strahan, Greer, SC (US); Dale S. Kitchen, Boiling Springs, SC (US); Patrick A. Petri, Greer, SC (US); Philip T. Wilson, Cincinnati, OH (US); Gregg J. Blaszak, Greenville, SC (US)

(72) Inventors: Venkatkrishna Raghavendran, Greer, SC (US); Bernhard Zeiler, Moore, SC (US); Qi Liao, Ann Arbor, MI (US); Jeffrey Strahan, Greer, SC (US); Dale S. Kitchen, Boiling Springs, SC (US); Patrick A. Petri, Greer, SC (US); Philip T. Wilson, Cincinnati, OH (US); Gregg J. Blaszak, Greenville, SC (US)

(21) Appl. No.: 14/036,756

(22) Filed: Sep. 25, 2013

Related U.S. Application Data
(60) Provisional application No. 61/711,370, filed on Oct. 9, 2012.
(60) Provisional application No. 61/826,737, filed on May 23, 2013.
(60) Provisional application No. 61/844,671, filed on Jul. 10, 2013.

(51) Int. Cl. E04B 1/04; B32B 13/02

(52) U.S. Cl. CPC E04B 1/04; B32B 13/02
USPC 428/34.4; 428/156; 428/167; 156/257

(57) ABSTRACT

A fiber reinforced polymer strengthening system containing a concrete or masonry structural member having at least one outer facing surface with at least one groove. The at least one groove contains at least one reinforcing element, where the reinforcing element contains a matrix material having a transition temperature of at least about 120° C. and a plurality of fibers having a tensile strength of at least about 1000 MPa. The groove also contains a binder comprising an inorganic material and is incombustible.

### RELATED APPLICATIONS

This application claims priority to provisional applications 61/741,370 (filed Oct. 9, 2012), 61/826,737 (filed May 23, 2013), and 61/844,671 (filed on Jul. 10, 2013), each of which is incorporated herein in their entirety.

### TECHNICAL FIELD

The present disclosure relates generally to fiber reinforced polymer strengthening systems, more particularly to fiber reinforced polymer strengthening systems for concrete and masonry structures for added strength and fire resistance.

### BACKGROUND

Concrete and other masonry or cementitious materials typically have high compressive strength but lower tensile strength. Thus, when using concrete as a structural member, for example, in a building, bridge, pipe, pier, culvert, tunnel, or the like, it is conventional to incorporate reinforcing members to impart the necessary tensile strength. Historically, the reinforcing members are steel or other metal reinforcing rods or bars, i.e., “rebar”. Such reinforcing members may be placed under tension to form pre-stressed or post-tensioned concrete structures.

Composite reinforcement materials, specifically fiber reinforced polymers (FRP), have been used to strengthen existing concrete and masonry structures. FRP are strong, lightweight, highly durable, and can be easily installed in areas of limited access. These fiber reinforced polymers typically contain a glass or carbon fiber textile that is embedded in a matrix.

FRPs used in the concrete reinforcements are typically made with carbon fibers and epoxy. These FRP materials generally are not able to withstand a fire event when the structure is subjected to fire and heat that can reach 2000° F. Due to these limitations, the FRP reinforcements are typically not considered for many structures requiring fire ratings or are designed to be secondary reinforcement in accordance with the guidance provided in ACI 440.2R. A fiber reinforced solution that can maintain its strength and contribute to the structural integrity of the strengthened member for the duration of a fire event beyond the provisions outlined in ACI 440.2R is presently an unmet need in concrete reinforcement applications (both at time of manufacture, during retrofitting or repairing an existing structure).

### BRIEF SUMMARY

A fiber reinforced polymer strengthening system containing a concrete or masonry structural member having at least one outer facing surface with at least one groove. The at least one groove contains at least one reinforcing element. The reinforcing element has a roughened surface and contains a matrix material having a transition temperature of at least about 120° C. and a plurality of fibers having a tensile strength of at least about 1000 MPa. The groove also contains a binder comprising an inorganic material and is incombustible. A method of making the fiber reinforced polymer strengthening system is also disclosed.

### BRIEF DESCRIPTION OF THE FIGURES

An embodiment of the present invention will now be described by way of example, with reference to the accompanying drawings.

FIG. 1 is a side view of one embodiment of the fiber reinforced polymer strengthening system containing a concrete or masonry structural member having at least one outer facing surface with a series of grooves and a plurality of reinforcing elements and a binder in the grooves.

FIG. 2 is a side view of one embodiment of the fiber reinforced polymer strengthening system containing a concrete or masonry structural member having at least one outer facing surface with a series of grooves and a plurality of reinforcing elements and a binder in the grooves and an insulating layer.

FIGS. 3 and 4 are images of reinforcing elements formed using a peel-ply textile.

FIGS. 5A, 6A and 7A are photographic images of a groove containing a reinforcing element and a spring.

FIGS. 5B, 6B, and 7B are line drawings of the photographic images of 5A, 6A, and 7A.

FIG. 8 is an isometric view of one embodiment of the fiber reinforced polymer strengthening system containing a concrete or masonry structural member having at least one outer facing surface with a series of grooves in two directions.

FIG. 9 is an isometric view of one embodiment of the fiber reinforced polymer strengthening system containing a concrete or masonry structural member having at least one outer facing surface with a series of grooves in two directions and an insulating layer.

FIG. 10 is an isometric view of one embodiment of the fiber fiber reinforced polymer strengthening system being a shear strengthening system.

### DETAILED DESCRIPTION

The fiber reinforced polymer strengthening system may be used in any cementitious system (including concrete, masonry, or brick structures) or any other suitable structure requiring additional reinforcement such as timber and steel structures. The fiber reinforced polymer strengthening system may be used in any suitable part of any suitable structure such as architectural structures (including buildings), foundations, brick/block walls, pavements, bridges/overpasses, motorways/roads, runways, parking structures, dams, tunnels, pools/reservoirs, pipes, footings for gates, fences and poles and even boats. Preferably, the fiber reinforced polymer strengthening system and all of the structures using the fiber reinforced polymer strengthening system pass the ASTM E-119 test.

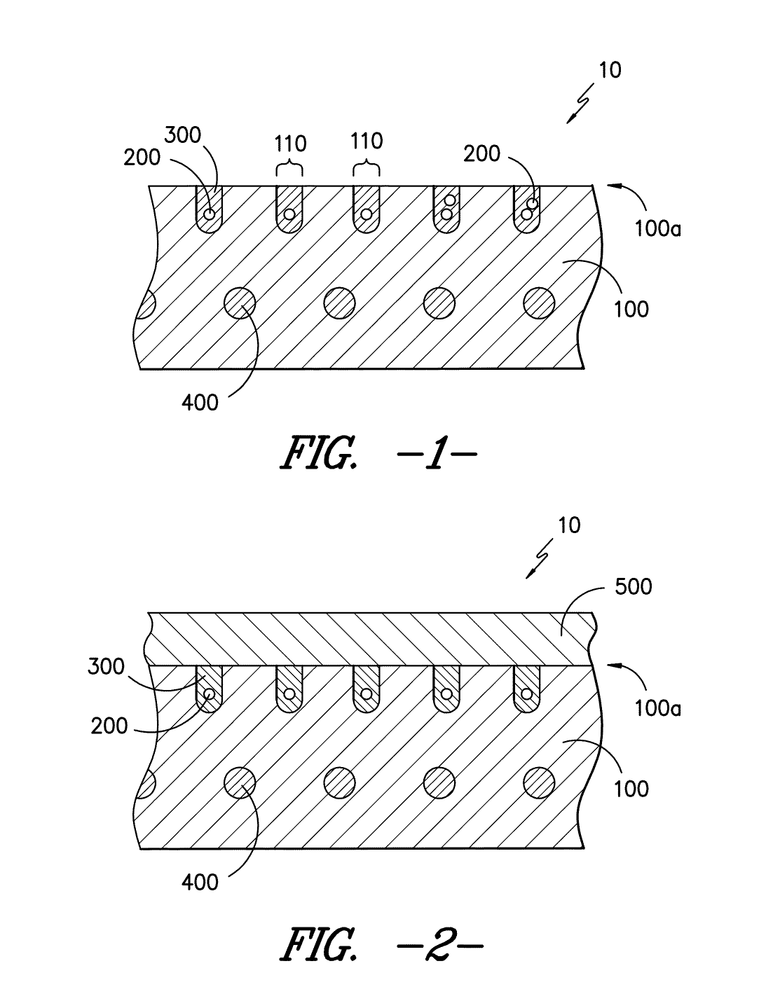

Referring now to FIG. 1, the fiber reinforced polymer strengthening system 10 contains a concrete or masonry structural member 100 having at least one groove 110 (FIG. 1 illustrates a series of grooves 110) in the outer facing surface 100a. In this embodiment, the concrete or masonry structural member 100 also contains rebar 400 which is typically steel. Within the grooves are a plurality of reinforcing elements 200 and a binder 300. As used in this application, the phrase “reinforcing element” is used to describe and encompass any fiber reinforced polymer prefabricated from various processes, including but not limited to pultrusion, micro-rod pultrusion, vacuum infusion, autoclave prepregs, resin transfer molding, and similar processes. The prefabricated fiber reinforced polymer can then be used as the reinforcing elements within the systems described herein.

The member 100 to be strengthened with the FRP strengthening system may be any suitable concrete or masonry structural member This includes, but is not limited to, framing elements, slabs, flat plates, beams, T-beams, girders, joists, walls, spandrel panels, and columns. Concrete is a composite construction material composed primarily of aggregate, cement, and water. There are many formulations that have varied properties. Concrete has relatively high compressive strength but much lower tensile strength. For this reason it is usually reinforced with materials that are strong in tension (often steel rebar).

The concrete or masonry structural member 100 typically contains reinforcements 400 in the form of steel or iron reinforcement bars (“rebars”), reinforcement grids, plates or fibers. In another embodiment, the reinforcements 400 may also be FRP or glass reinforced plastic (GRP) which primarily consist of fibers of polymer, glass, carbon, basalt, aramid, or other high-strength fibers set in a resin matrix to form a rebar rod or grid or fibers.

The concrete or masonry structural member 100 contains at least one outer facing surface 100a. The outer facing surface preferably is in tension. In one embodiment, there are a series of grooves 110 on at least a portion of the outer surface 100a such as shown in FIG. 1. In one embodiment, the outer facing surface contains only one groove; in other embodiments the outer facing surface contains a plurality of grooves. The grooves may also be referred to as slots, troughs, niches, or slits. These grooves enable the “near surface mounted” (NSM) applications of the reinforcing elements. Embedding the pultruded members in grooves helps prevent some of the undesirable failure modes associated with traditional fabric-style FRP systems, like peeling and concrete cover delamination. The NSM technique is also advantageous in a fire as the strengthening reinforcements can be encapsulated in an inorganic, incombustible binder, placed within the concrete member.

In one embodiment, the grooves are shallow, narrow width slots that range from about ⅛″ to 1″ wide and about ¼″ to 1½″ deep, and depend on the size and shape of the reinforcing element or elements to be placed in the groove. In one embodiment, the width of the cut in the concrete is approximately one and a half times the diameter (or thickness for elements having a rectangular cross-section) of the reinforcing element 200. In one embodiment, the grooves 110 take up about 5 to 50% of the surface area of the outer facing surface 100a of the concrete or masonry structural member 100. In another embodiment, the grooves 110 form about 5-25% of the surface area of the outer facing surface 100a of the concrete or masonry structural member 100. There is preferably enough concrete between the grooves to prevent or reduce concrete splitting. In one embodiment, there are about 1 to 4 inches between the grooves 110.

A groove 110 may be formed by several means of cutting and/or chiseling. In one embodiment, the groove 110 is formed by first cutting two parallel cuts in the concrete, each cut located at the outer edges of the groove 110 to be formed. The concrete between the two parallel cuts can then be removed, such as with a chisel, to form the full groove 110.

Depending on the application, grooves 110 can be cut using a variety of concrete or masonry cutting tools. Traditional applications for NSM reinforcements have been applied to the top of concrete slabs (typically in the negative moment areas), such as the top of a bridge deck. In such cases, heavy cutting saws that are push operated are typically used to create straight cuts. However, for the overhead applications that add tensile strengthening to the bottom of beams and slabs or shear strengthening to the sides of beams, such heavy tools may be impractical. Lightweight manual tools or mountable cutting systems on a track can be used for easier cutting. One such cutting system is disclosed in U.S. Provisional Application 61/759,481, filed Feb. 1, 2013 and is herein incorporated by reference. Guides may be attached to the face to help guide hand-held saws for straight cuts. Hand-operated tools that are lightweight and may be used overheard include a rotating “tuckpoint” blade on a lightweight, high rpm hand-held grinder or a “wall chaser” concrete saw. Often hand-held saws and grinders may use a blade cover with vacuum attachments to contain the dust generated during the cutting operation. In some cases, such as for shear strengthening on the sides of beams, grooves may be cut along the side outer face of the beam. The grooves can be cut perpendicular to the bottom along the side outer face, or alternatively at an angle, such as 45 degrees, to further enhance the shear strengthening of the reinforcing element. When the structural member 100 is adjacent to another structural member, the reinforcing element may be anchored further into the adjacent structural member by drilling a hole or continuing the groove into the adjacent structure in line with the groove 110.

Within at least a portion of the groove(s) 110 is at least one reinforcing element 200. In one embodiment, there are some grooves that contain no reinforcing elements 200. In another embodiment, at least a portion of the grooves 110 contains one reinforcing element 200 each such as shown in FIG. 1. In another embodiment, at least a portion of the grooves 110 contain more than one reinforcing element 200 each.

In one embodiment, more than one reinforcing element 200 is inserted into a single groove. More than one reinforcing element 200 may be inserted into each groove 110 or only select grooves 110 such as shown in FIG. 1. The reinforcing elements 200 may be inserted independently or may be bundled together and inserted into the group as a bundle of elements. This bundle may consist of two elements, three elements, four elements, or 5 or more elements inserted into a single groove 110. A bundle of elements can be formed through several formation techniques, including formed into a textile or network including but not limited to woven, knit, nonwoven, unidirectional, and scrim textiles. Alternatively the bundle can be formed using adhesives, binders, or mechanical fastening means such as metal ties or spacers, which can be placed periodically along the bundles. In one embodiment, the spacers also act as an insertion piece to help hold the bundle of reinforcing elements 200 in the groove 110 while the binder 300 is inserted and cured in the groove 110. In some embodiments, the spacers act as additional mechanical anchoring for the individual reinforcing elements 200 in the groove 110. The spacers may consist of metals, polymers, or ceramic materials. Various washers, ferrules, compression fittings, wedges, or machined parts may be used to provide spacing and clamping to each element. In one embodiment, the clamping mechanism at each spacer tightens as the pultruded member is placed in tension.

The reinforcing elements may be made of any suitable materials and in one embodiment include a plurality of fibers and a matrix material. In addition to fibers, the reinforcing elements 200 contain a matrix material. The matrix material provides transfer of the mechanical load between individual fibers within the reinforcing element. The mechanical properties of the matrix and bond with the fibers allow for transfer of the tensile load between fibers. For example, chemical sizing on the fibers can enhance the matrix bond to the fibers. Previously, matrices with low transition temperatures have been used for reinforcing elements. The transition temperature of the matrix is described by a transition region where the mechanical properties of the matrix substantially decrease, such as at a melt transition temperature common in thermoplastic matrices or a glass transition temperature common in thermoset matrices. Previously reinforcing elements or fiber reinforced polymer systems have used ambient temperature cured resins with transition temperatures below 108° C., and more typically with a transition temperature ranging from 60° C. to 85° C. For a matrix material with a low transition temperature, such as ambient temperature cured adhesives (e.g. epoxy, vinyl-ester, and polyester resins), the composite operating temperature of the reinforcing element is limited by the low transition temperature of the matrix and may not be suitable to systems designed to withstand a fire event. Preferably, the matrix material has a transition temperature of at least about 120° C., more preferably at least about 150° C., at least about 180° C., at least about 200° C., at least about 250° C., at least about 270° C., or at least about 300° C. The matrix material may be any suitable high transition temperature matrix material. For example, materials with a high glass transition temperature (T_{g}) can include epoxies, epoxy novolacs, anhydride-cured epoxies, cyanate esters, or phenolics. Some high transition temperature thermoplastic materials may also be considered for the matrix material such as polyimides, polyether ether ketone (PEEK), polyamide imide (PAI), polysulfones, nylons, polyesters, polycarbonates, polyolefins, or the like, wherein a melting temperature (Tₘ), may best define the transition temperature of the material. Typically, high temperature processing is required for high transition temperature materials, and therefore it may be preferable to process the reinforcing elements in a controlled environment rather than the work site.

The fibers are preferably made of a material having a high tensile strength. In one embodiment, the fibers have a tensile strength of greater than about 1000 MPa, more preferably greater than 2000 MPa, more preferably greater than 2500 MPa. In one embodiment, the fibers preferably retain their high tensile strength of greater than 1000 MPa to at least the transition temperature of the matrix material. High strength materials such as steel, carbon, basalt, aramid, polybenzoxazole (PBO), and glass fibers are suitable for many strengthening applications. Carbon fiber is preferred due to its high tensile strength, modulus, and low creep. The fibers may contain a single type of fiber material or a mixture of different fiber materials.

The reinforcing elements 200 can have any suitable cross-sectional shape, diameter, and length. In one embodiment, the reinforcing elements 200 have a circular cross-sectional shape and are typically referred to as pultruded rods. A circular shape is preferred for ease of manufacture and handing as well as high packing of fiber into a given volume. In another embodiment, the reinforcing elements 200 may have a non-circular cross-section which may be, but is not limited to, elliptical, rectangular, square, multi-lobal, and any of the aforementioned shapes with mechanically modified features, such as by forming, cutting, or machining. In another embodiment, the reinforcing elements 200 have a rectangular cross-sectional shape which may be preferred for some embodiment for providing a higher surface area to bond the reinforcing element 200 to the binder 300 inside the groove and ease of manufacturing. Reinforcing elements 200 with a rectangular cross-sectional shape are also sometimes referred to as strips, ribbons, or tapes. In another embodiment, the reinforcing elements 200 are hollow, which could include round or rectangular cross sections or partially open c- or u-shaped cross-sections. A hollow or partially open cross-section has the advantage that additional materials could be embedded, such as a high heat capacity or phase change material to keep the elements from heating as quickly. In addition, the hollow shape may allow for filling of the binder 300 into the groove by pumping into the hollow member. Optionally holes could be added or a c- or u-shaped element to allow the binder 300 to fill the entire groove.

In one embodiment, the reinforcing elements 200 have a length at least about two times the development length. The “development length” is the shortest length of the reinforcing rod or strip to develop its required contribution to the moment capacity of the structure. The development length is dependent on the shear strength between the binder 300 and the concrete member 100, the shear strength between the binder 300 and the reinforcing element 200, and the tensile strength and size of the reinforcing element. The reinforcing elements 200 have a length and a width (the width is the average width of the cross-sectional shape) with a width to length aspect ratio of preferably at least about 1:10.

One method for manufacturing the reinforcing elements 200 known as pultrusion involves drawing a bundle of reinforcing material (e.g., fibers or fiber filaments) from a source thereof, wetting the fibers, and impregnating them (with the matrix material) by passing the fibers through a resin bath in an open tank, pulling the resin-wetted and impregnated bundle through a shaping die to align the fiber bundle, manipulating it into the proper cross-sectional configuration, and curing the resin in a mold while maintaining tension on the filaments. Because the fibers progress completely through the pultrusion process without being cut or chopped, the resulting products generally have exceptionally high tensile strength in the longitudinal direction (i.e., in the direction the fiber filaments are pulled). Exemplary pultrusion techniques are described in U.S. Pat. No. 3,793,108 to Goldsworthy; U.S. Pat. No. 4,394,338 to Fuwa; U.S. Pat. No. 4,445,957 to Harvey; and U.S. Pat. No. 5,174,844 to Tong. Similar processes may likewise be used to create the reinforcing element and include, but are not limited to, pultrusion, micro-rod pultrusion, vacuum infusion, autoclave prepregs, or resin transfer molding.

The plurality of grooves 110 contains a binder 300 and a strong bond is preferred between the reinforcing element 200 and binder 300. To enhance the interfacial mechanical bond, methods have been developed to enhance the surface area of the reinforcing elements 200 by giving the reinforcing element 200 a roughened surface texture. Roughened, this is application includes textured. Some methods to impart a roughened surface on the reinforcing elements 200 include embedding small particles into the surface of the reinforcing element, winding and bonding additional fibers or filaments around the reinforcing element, adding ribs or other structural shapes to the cross section of the reinforcing element 200, or peeling away a layer of material partially covering the reinforcing element surface to create groove patterns.

In one embodiment, the reinforcing elements 200 comprise inorganic particles, such as sand, covering at least a portion of the surface of the reinforcing element, wherein the inorganic particles are adhered to the reinforcing element using the matrix material of the reinforcing element 200 or another adhesive material having a high transition temperature (the adhesive preferably has a transition temperature at least about the transition temperature of the matrix material or at least about 120° C.). In another embodiment, the reinforcing elements 200 may have bends, notches, or accordion shapes (along the length direction) of the reinforcing elements 200 to prevent or reduce slippage of the reinforcing elements 200 within the system 10.

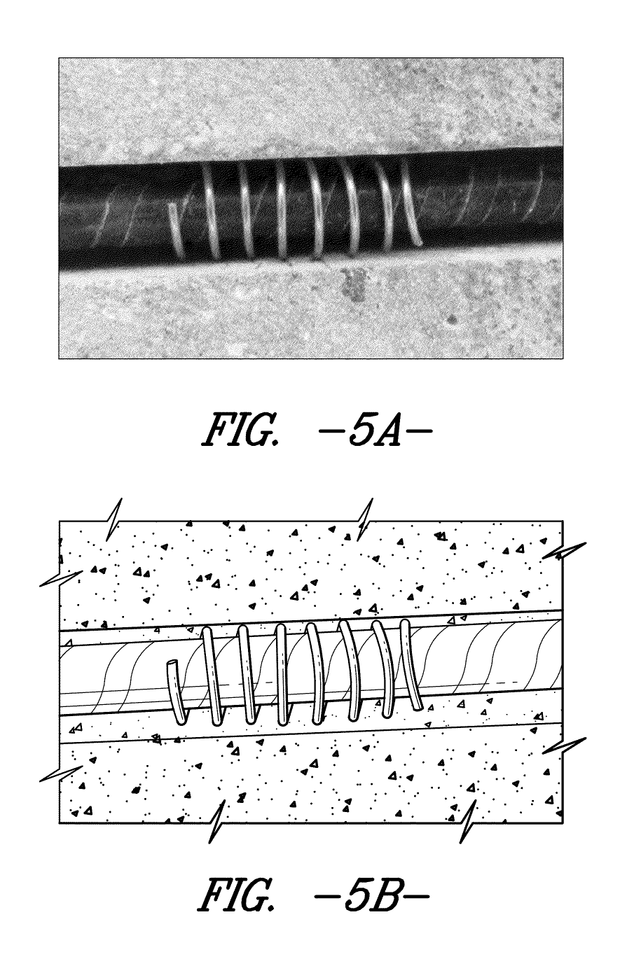

In another embodiment, the reinforcing element 200 may also be fabricated in such a way to create grooves or spiral indentations along the length direction of the member. In one embodiment, a pultruded member is given surface roughness with a peel-ply textile. The peel-ply can be removed after the pultrusion step to yield a spiral indentation on the reinforcing element 200. Images of one embodiment of a reinforcing element having a spiral indentation from a peel-ply fabric are shown in FIGS. 3 and 4. The peel-ply textile may yield a spiral indentation, creating a portion of the surface with a raised area (lug) and a portion of the surface with an indented area (groove). The spiral indentation can be defined by the wrapping angle or pitch and can be varied from nearly perpendicular to the length of the reinforcing element (0 degrees) to running nearly parallel to the length of the rod (90 degrees). Preferably, the wrapping angle is no less than 5 degrees and no more than 60 degrees. The width of the peel-ply textile used can be from 0.005 inch to 2 inch. In one embodiment, the peel-ply textile has a width no less than 10% of the diameter of the pultruded member and no greater than 200% the diameter of the pultruded member. More preferably the width of the peel-ply is no less than 25% of the diameter of the pultruded member and no greater than 100% the diameter of the pultruded member. The ratio of the lug to the groove is set by the wrapping angle or pitch and width of the peel-ply. Preferably, the ratio of the surface area of the lug to the surface area of the groove is no less than 0.1 and no greater than 10. More preferably the ratio is no less than 0.5 and no greater than 3. The thickness of the peel-ply and hence the depth of the spiral indention or groove can be from 0.001 inch to 0.125 inch. In one embodiment, the thickness of the peel-ply is no less than 0.1% of the diameter of the pultruded member and no greater than 12.5% of the diameter of the pultruded member. More preferably, the thickness of the peel-ply is no less than 1% of the diameter of the pultruded member and no greater than 6% of the diameter of the pultruded member. In other embodiments, the peel-ply could be a ribbon, a fiber, a yarn and could have texture and shape. In addition, multiple wraps can be applied simultaneously with the same or varying wrapping angle, width and thickness, and could have the same spiral handedness or opposing handedness.

The binder 300 may be any binder that is suitable for the end use. The binder 300 is used to achieve binding when the reinforcing elements 200 are attached to the concrete or masonry structural member 100 inside the groove 110. In one embodiment, the binder 300 contains an inorganic mixture, and may be referred to as a grout or mortar, that can contain sand or fine inorganic particles mixed with hydraulic cements such as Ordinary Portland Cement (OPC) or acid base cements such as magnesium phosphates, aluminosilicates and phosphosilicates. Admixtures such as setting accelerators, retarders, and super plasticizers can be added to these inorganic binders to tailor their setting and curing times and strength. To effectively transfer the stresses from the concrete to the reinforcing elements, these binders 300 preferably are able to develop sufficient early compressive strength equal to or greater than the concrete compressive strength. Additionally, to maintain the composite action these binders 300 preferably are low- or non-shrinking to preclude debonding from either the concrete substrate or the reinforcing element 200 embedded inside it. In one embodiment, the concrete or masonry structural 100 element contains pores and at least a portion of the binder 300 penetrates in those pores.

The binder 300 is also preferably incombustible, meaning that it does not burn or decompose when exposed to fire, and preferably is as incombustible as the concrete or masonry structural member 100. The binder 300 may contain, for example, various cementitious materials or high temperature epoxy grouts, and may contain inorganic aggregates, pozzolanic minerals, polysialate geopolymers, and phosphate based chemically bonded ceramics. Preferably, the binder 300 comprises a cementitious material. Cementitious material is preferred for its incombustibility and fire resistance, similar to the concrete and masonry structural member 100. In one embodiment, the concrete or masonry structural member 100 contains pores and at least a portion of the binder 300 penetrates in those pores.

In one embodiment, the binder 300 is not inorganic but is an organic material having a high transition temperature. Several alternative organic resins can be considered, such as anhydride-cured epoxies, cyanate ester, and phenolic resins. Additional inorganic resins might also be used, such as metal matrices, ceramics, and other cementitious mixtures.

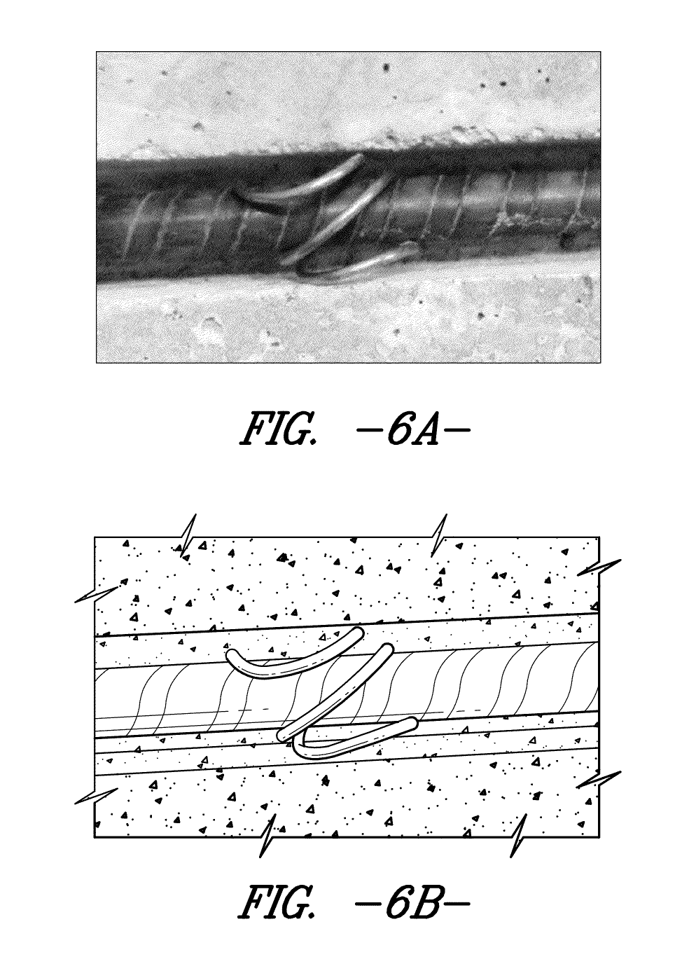

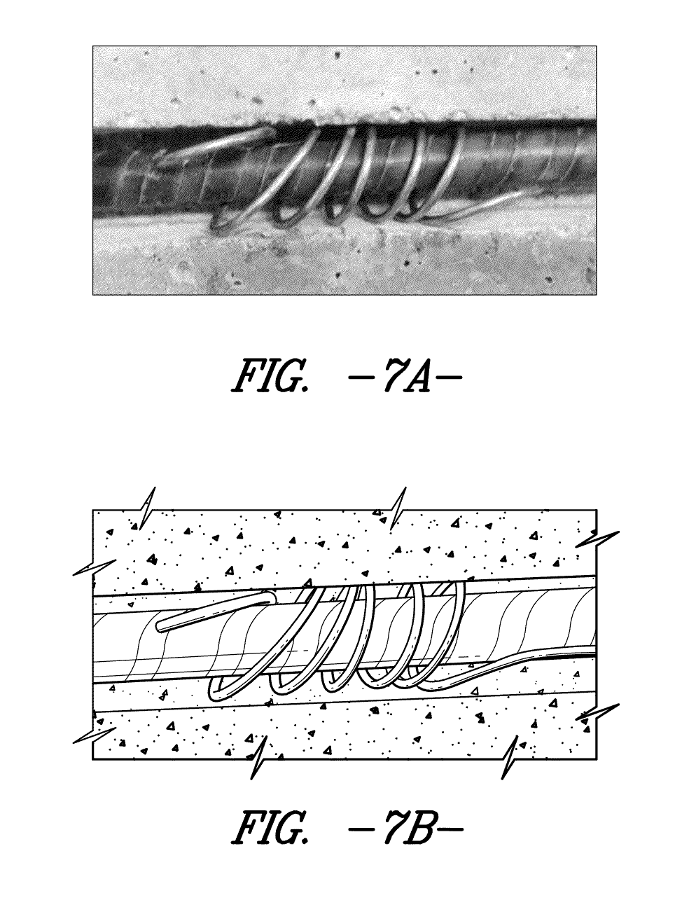

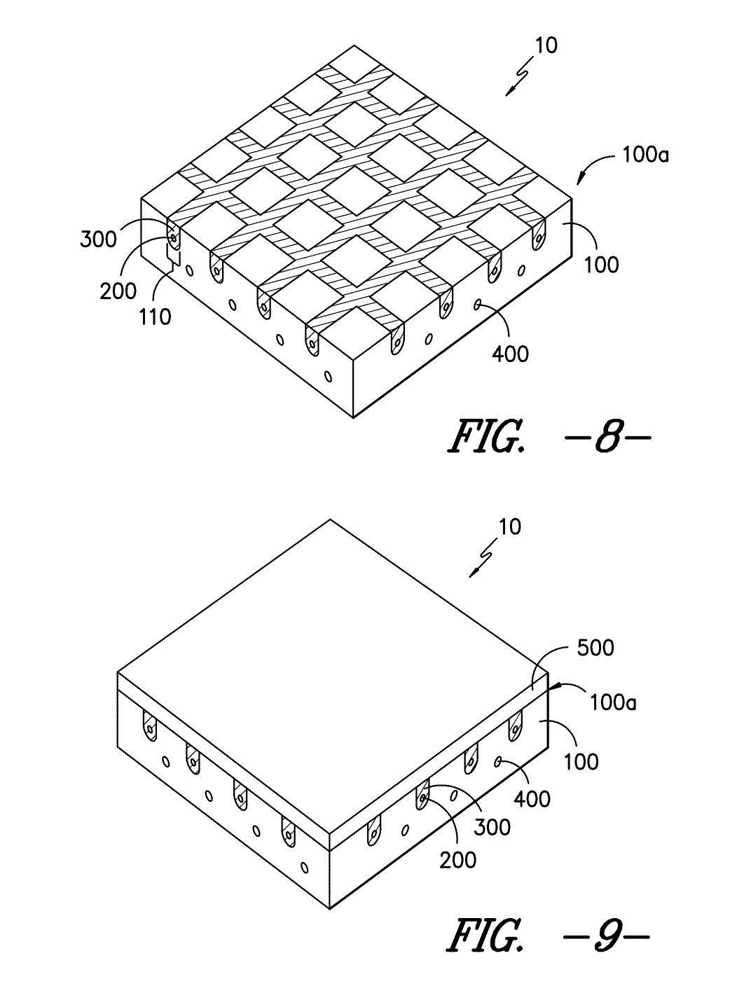

Referring back to FIG. 1, both the reinforcing elements 200 and the inorganic material 300 are located in at least one groove 110 of the concrete or masonry structural member 100. This may be accomplished in a variety of methods. The reinforcing elements 200 may be inserted into the slots with the aid of optional fasteners. The fasteners can be used to hold the reinforcing elements 200 in the slot against gravity and to set the correct depth of the reinforcing elements 200 in the slot. Because the reinforcing elements 200 can be much lighter than traditional steel members, simple, lightweight fasteners can be employed. In one embodiment, springs are used to secure, support, or reinforce the binder and reinforcing element within the groove. The springs can be made of any material such as metals, thermoplastics, thermosets, ceramics, composites, FRP, GRP or similar. Preferably the material is corrosion resistant and can be readily formed into a small spring to secure the reinforcing element 200, such as stainless steel, galvanized steel or aluminum springs. In one embodiment a short length of a stainless steel spring with an outer diameter approximately equal to the width of the groove 110 and an inner diameter larger than the diameter of the reinforcing element 200 encompasses a portion of the reinforcing element 200 and secures the element within the groove, such as shown as a photo in FIG. 5A (and shown as a line drawing in FIG. 5B). In another embodiment, a short length of stainless steel spring is placed perpendicular to the reinforcing element 200, wherein a portion of the spring stretches across the element, and the end portions of the spring are under compression against the side walls of the groove 110, as shown as a photo in FIG. 6A (and shown as a line drawing in FIG. 6B). In another embodiment, a longer section of spring encompasses a portion or the entire length of the reinforcing element 200, such as shown in the photo of FIG. 7A (and shown as a line drawing in FIG. 7B). In addition to securing the reinforcing element, a longer portion of the spring may act to reinforce or strengthen the binder 300 within the groove. Preferably a higher strength spring material with corrosion resistance, such as a stainless steel spring, is used to secure the reinforcing element 100 and reinforce the binder 300.

The reinforcing elements can be inserted into the groove either before or after application of the binder 300 but may require fastening support until the binder has cured or set. In one embodiment, the reinforcing elements 200 are introduced into the groove first followed by the binder 300. In another embodiment, the binder 300 is introduced into the groove first followed by the reinforcing elements 200. In another embodiment, the reinforcing elements 200 and the binder 300 are introduced into the groove simultaneously. In another embodiment, the grooves are partially filled with the binder 300, then the reinforcing elements 200 are introduced into the groove, then the rest of the groove is filled with additional binder 300. Preferably, the reinforcing elements 200 and binder 300 are added such that the binder 300 surrounds and encapsulates the reinforcing elements 200. “Surrounds” and “encapsulates” in this application means that essentially all (preferably at least 85%) of the surface area of the reinforcing element is covered by the binder.

A typical strengthening of a concrete slab, beam or joist can require a span up to 25 feet or more and may have several, parallel reinforcing elements. Optimally a continuous length of reinforcing element should be applied over the entire span and installation of each reinforcing element is preferably uninterrupted so the binder does not cure until the installation of the reinforcing element is complete. Alternatively, shorter reinforcing elements may be overlapped to cover the entire span. The installation method and binder should allow for effective encapsulation of each reinforcing element by the binder within the grooves. Any suitable method for installing the binder to encapsulate the reinforcing element may be used such as trowelling, caulking, pumping, or spraying.

In one embodiment, a form work can be placed over the groove 110 to seal the groove off for pumping along its length. With a form work in place, the binder can be pumped by filling from one end of the groove until it fills the groove and exits the other end. In one embodiment, a form material is bonded to the concrete face on either side of the groove. The form material and adhesive can be a single system, such as a reinforced tape material that spans across the groove, or the form material may be separate from the adhesive. Form materials may include flexible or semi-flexible textiles (including wovens, knits, or non-wovens), films, or foils; or the form may be rigid and semi-rigid boards or sheets of plastics, metals, woods, or glass. In one embodiment, the form material is a tape backing with scrim reinforcement. In another embodiment, the form material is a transparent or semi-transparent clear film bonded with a butyl-rubber adhesive. In another embodiment, the form material is a transparent or semi-transparent plastic sheet. In another embodiment, the form material is a foamed adhesive tape with a reinforced backing film that is semi-transparent. Transparent or semi-transparent form materials provide the advantage of visual confirmation of the pumping operation as the groove is being filled with the binder. Other form materials may be used to provide other benefits, such as metal sheeting or insulation board materials to provide enhancement to the heat shielding of the system. In other embodiments, textiles or membranes that contain liquid but breathe can be used to tailor the curing process of the binder.

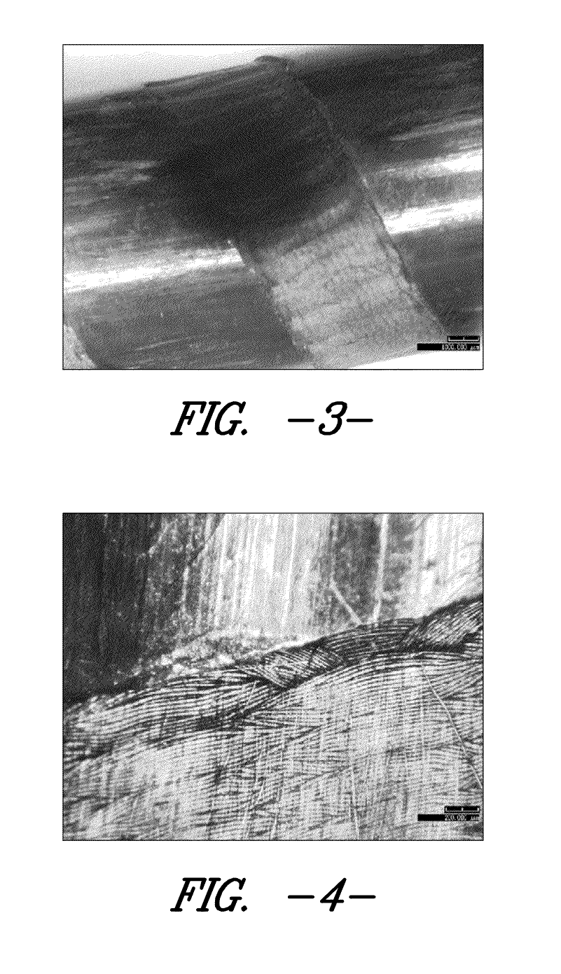

Referring back to FIG. 2, there is shown one embodiment where the fiber reinforced polymer strengthening system 10 contains an insulation layer 500. The insulation layer 500 may be optionally added to the fiber reinforced polymer strengthening system 10 for added fire and temperature protection for the concrete member 100, reinforcing elements 200, and binder 300. The insulation layer 500 may be any suitable insulation layer 500 formed of any suitable material, weight, and thickness. The insulation layer 500 preferably is incombustible and provides a thermal barrier to the polymer strengthening system during a fire event, such as simulated in an ASTM E119 fire test. The insulation layer 500 preferably keeps the reinforcing element 200 below 200° C. for at least 60 minutes (more preferably at least 120 minutes, more preferably at least 180 minutes, more preferably at least 240 minutes) during an ASTM E119 fire test. Preferably, the insulation layer is self-supporting, durable to handling, and durable to environmental exposure.

In one embodiment, the insulation layer contains a majority of ceramic fibers by weight and a minority of organic binding agents by weight. In another embodiment, the insulation layer 500 may contain an intumescent paint. In another embodiment, the insulation layer 500 may contain a mineral or refractory fiber blanket. In another embodiment, the insulation layer 500 may contain a semi rigid board, such as rockwool or other mineral fibers. In another embodiment, the insulation layer 500 may contain a cementitious fireproofing insulation material that consists of one or all of cement, vermiculite, gypsum, fibers, light weight aggregates, or similar materials. In another embodiment, the insulation layer 500 may contain an aerogel insulation blanket. In another embodiment, the insulation layer 500 may contain gypsum board or a magnesium oxide board.

In one embodiment, the insulation contains at least one layer of a mineral fiber or refractory blanket adjacent the groove containing the reinforcing element. This blanket is then covered with one or more moisture bearing mineral boards that can optionally have a reflective radiant barrier like aluminum foil attached to one or both surfaces. The moisture bearing mineral board preferably keeps the reinforcing element 200 below 200° C. for at least 60 minutes (more preferably at least 120 minutes, more preferably at least 180 minutes, more preferably at least 240 minutes) during an ASTM E119 fire test.

The board is self-supporting, durable to handling and impact, and resistant to environmental exposure. The moisture bearing mineral board can be a Gypsum board such as fire rated Type X or Type C board or Magnesium oxide boards.

The insulation layer could be a combination of any of the above listed categories of insulation materials or any other suitable insulating materials. In one embodiment, the insulation layer 500 may contain 2, 3, 4, or more sub-layers, where each of the sub-layers may be any suitable insulation layer such as those insulation materials described in this application. The detailed thickness and sequences of construction of different insulations will be based on considerations such as cost, durability, installation, as well as desired duration of protection from fire.

In one embodiment, the insulation layer 500 is attached to the outer surface of the concrete or masonry structural member 100 covering at least a portion of the grooves 110. Preferably, the insulation layer 500 covers essentially all of the grooves 110 and therefore covers essentially all of the reinforcing elements 200 and the binder 300. The insulation layer 500 is preferably attached to the outer surface 100a of the concrete or masonry structural member 100 such that the protection remains intact for sufficient time to provide the targeted protection during a fire event. Various high temperature binders or adhesives as well as mechanical fasteners may be used to ensure adequate bond. In addition, the insulation itself should preferably have sufficient integrity to not fall apart or debond from itself for sufficient time to provide the targeted protection during the fire event. For combinations of insulation materials, the bond of the layers should preferably be adequate that each layer remains attached to the underside of the concrete or masonry structure, such that the targeted duration of protection is achieved. In one embodiment, the insulation layer 500 is bound to the surface 100a with the same binder as the binder 300 used in the fiber reinforced polymer strengthening system 10. In one embodiment, the adhesive used to bond the insulation layer 500 and the concrete or masonry structural member 100 has a transition temperature of at least about the transition temperature of the matrix material.

In one embodiment, there may optionally be an intermediate layer which facilitates the bonding or intimate contacting between the insulation layer 500 and the concrete or masonry structural member 100. An example of such an intermediate layer can be any suitable inorganic binder to bond to both the concrete or masonry structural member 100 and the insulation layer 500. In another embodiment, the intermediate layer is a conformable layer such as a thin layer of fiberglass, mineral fiber, or refractory blanket which will, upon compression, conform to the surface contour of the concrete or masonry structural member 100 or insulation layer 500 to ensure intimate contact between them. In another embodiment, the layer is a compressible ceramic blanket. In another embodiment a ceramic fiber paste or intumescent paint can be caulked, troweled, or otherwise applied to fill gaps and seal seams.

In another embodiment, the insulation layer is attached to the outer surface 100a of the concrete or masonry structural member 100 by a mechanical means. This mechanical means may be any suitable mechanical fastener for the end use including but not limited to concrete nails, pins, screws, nails, bolts, nuts, washers, screws, stud anchors, removable bolt anchors, high strength drive anchors, pin-drive anchors, internally threaded anchors, toggle anchors, spikes, rivets, and staples. The mechanical fasteners might be covered with an intumescent coating or ceramic fiber paste to provide a level of thermal protection. The mechanical support can also include channels, braces, or meshes, made from suitable materials, such as metals (including, steel, stainless steel, galvanized steel), ceramics, or similar high temperature materials. Channel supports could include z-shaped, c-shaped, hat-shaped, I-beam shaped, or similar channels that can be attached to both the surface 100a and insulation layer 500 or otherwise support the insulation layer. Braces and meshes could be referred to as strips, straps, covers, sheets or similar to support the insulation layer and can be used with channels or alone to support the insulation layer 500 against the surface 100a.

One process to form a fiber reinforcing polymer strengthening system with an insulation layer begins with obtaining a preformed and cured concrete or masonry structural member having at least one outer face. A series of cuts are formed in the outer facing surface. In one embodiment, the reinforcing elements 200 are introduced into the groove first followed by the binder 300. In another embodiment, the binder 300 is introduced into the groove first followed by the reinforcing elements 200. In another embodiment, the reinforcing elements 200 and the binder 300 are introduced into the groove simultaneously. In another embodiment, the grooves are partially filled with the binder 300, then the reinforcing elements 200 are introduced into the groove, then the rest of the groove is filled with additional binder 300. The binder is added to the grooves in an uncured state and then cured in place. Preferably, the binder 300 cures at ambient temperature for easier installation on site. Next, optionally an insulation layer 500 is added to the system adjacent the outer facing surface 100a covering at least a portion (and preferably all) of the reinforcing elements 200. Once the fiber reinforcing polymer strengthening system is constructed, the system preferably has fire resistance providing a fire rating standard when tested per ASTM E119.

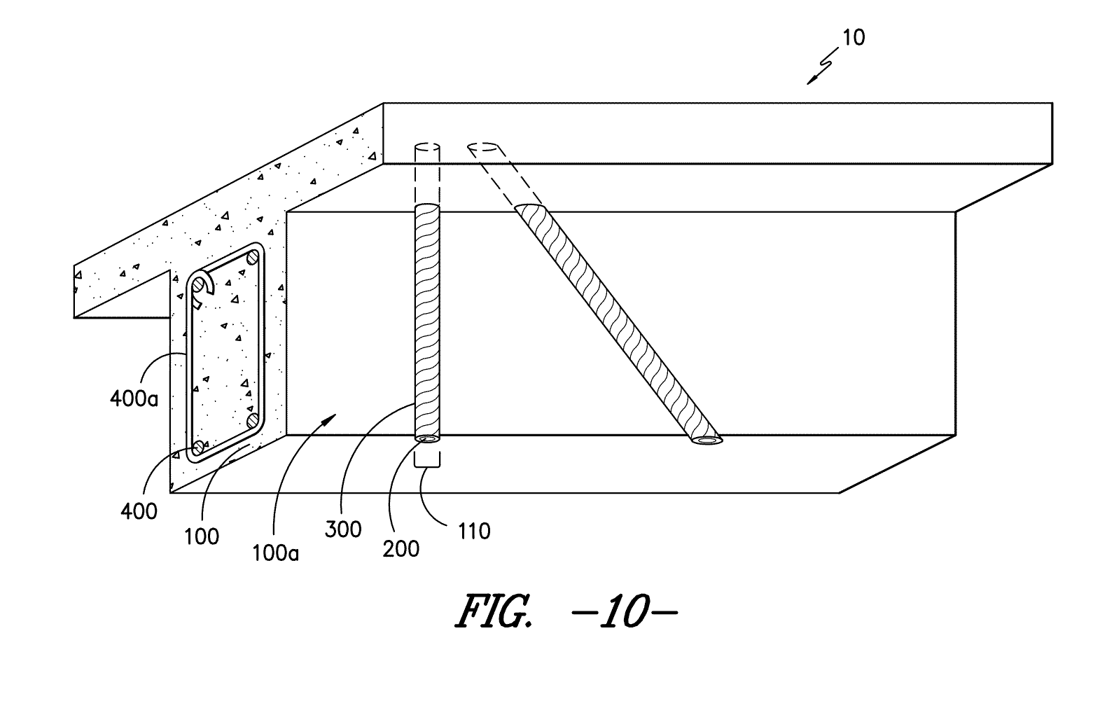

Referring now to FIGS. 8 and 9, there are shown two embodiments of the fiber reinforced polymer strengthening system being a two way strengthening system. In many structures, strengthening may be required in two-directions due to the structure being supported on all ends. For example, in a reinforced concrete rectangular slab, the slab may be supported on all four edges, referred to as a two-way slab. Two sets of reinforcing steel run in perpendicular directions between the supports to provide tensile strength and stability in both directions between the end supports. Strengthening a two-way structure with a fiber reinforced polymer strengthening system may require applying the strengthening system parallel to each set of the underlying reinforcing steel.

In FIG. 8, the fiber reinforced polymer strengthening system 10 contains a concrete or masonry structural member 100 having a series of grooves 110 in the outer facing surface 100a. In this embodiment, the series of grooves form a grid pattern, with the grooves intersecting other grooves, generally with the intersections being perpendicular. A set of grooves are cut in one direction, generally parallel to one set of reinforcing steel. A second set of grooves are cut in a second direction, generally perpendicular to the first set of grooves, and generally parallel to the second set of reinforcing steel. In general a first set of reinforcing steel may be closer to the concrete face than the set running perpendicular to the first. Grooves may be cut deeper that are parallel to the shallower rebar, cut in between the locations of the steel rebar. Grooves cut perpendicular to the shallower rebar can be shallower to prevent cutting into the rebar. The reinforcing element can be inserted first in the direction with the deeper grooves and second in the direction with the shallower grooves. In general, the number of grooves can be the same or different in the two directions. More strengthening can be applied in one direction of the structure than the other. Additionally, smaller grooves for smaller reinforcing elements can also be applied in one or both directions. In general the strengthening system is applied parallel to the underlying steel, but may be applied at different angles.

The materials (rebar, insulation, binder, etc.) and processes used to create the 2-way system shown in FIGS. 8 and 9 can be the same as for the single way system (such as shown in FIG. 1) except for the intersections created by overlaying two sets of perpendicular grids. The placement of the reinforcing elements in two directions creates intersection points. In general, reinforcing elements are placed in a first set of parallel grooves and then placed in a second set of parallel grooves running generally perpendicular to the first set of grooves, such that the first set and second set of reinforcing elements overlap at the intersections of the grooves. In another embodiment, the intersecting grooves form an angle of between about 20 and 90 degrees, more preferably between about 45 and 90 degrees. The second set of reinforcing elements can be placed directly against the first set or with a gap. The grooves can be cut to the same depth and widths or differing depths and widths. In addition, a two-way system may accommodate more than one size of reinforcing element. For example a larger reinforcing element may be placed in the first direction of grooves and a smaller reinforcing element may be placed in the second set of grooves. The depth of the cuts may be limited by the underlying steel rebar, such that one direction of cuts may be shallower than another and may require a smaller reinforcing element.

The processes and materials used to pump the 2-way system shown in FIGS. 8 and 9 can be the same as for the single way system (such as shown in FIG. 1) except that the intersections created by overlaying two sets of perpendicular grids interconnect the entire grid during the pumping process. The form work applied for pumping must seal off the grooves in both directions as well as seal the intersection points. As the grooves are interconnected, the pumping can be achieved by filling from ports at the end of each groove or by pumping from fewer ports, such as at the corners of the grid system. Pumping can be done with multiple ports and multiple pumps.

Insulation may still be preferred (or even necessary) to maintain the reinforcing elements 200 below their maximum operating temperature for sufficient duration in a fire event. As the grooves intersect in both directions in a 2-way slab, it may be necessary to cover nearly all of the area affected by the reinforcing elements 200. For instance, the insulation can be continuous or immediately adjacent layers such that the entire grid of grooves 110 and reinforcing elements 200 are covered. The same insulation materials and layers, as well as the same means for fastening or supporting the insulation can be applied to a 2-way slab.

Referring now to FIG. 10, there is shown an embodiment of the fiber reinforced polymer strengthening system being a shear strengthening system. In many structures, strengthening may be required in the shear face. For example, in a beam or T-beam, the structure may need strengthening along the side face of the beam, in addition to or without flexural strengthening of the bottom face of the beam. Typically reinforcing steel runs along the length of the beam as a tensile member as well as shear reinforcing steel wrapped around the tensile steel, perpendicular, and at varying intervals along the length of the beam. Shear strengthening a beam or T-beam with a fiber reinforced polymer strengthening system may require applying the strengthening system parallel to the shear bands or at an angle along the shear face.

The fiber reinforced polymer strengthening system 10 contains a concrete or masonry structural member 100 having a series of grooves 110 in the outer facing surface 100a, or the shear face. In this embodiment, the series of grooves may be formed perpendicular to the bottom face along the shear face or may be cut at an angle along the shear face, as shown in FIG. 10. In addition, the groove can extend into or completely through the t-section of a t-beam or into or completely through a slab resting on a beam as a hole or slot to allow for additional anchoring of the reinforcing element to the concrete or masonry structural member 100.

The materials (rebar, insulation, binder, etc.) and processes used to create the shear system in FIG. 10 can be the same as for the flexural systems (such as shown in FIG. 1). In general, the reinforcing elements 200 are placed in the grooves 110 cut along the shear face and can also be inserted into the optional holes or slots at the top of the grooves. The processes to place the binder 300, such as by forming and pumping, described herein for the flexural systems can similarly be used for the shear system. In addition, the form work applied for pumping must seal off the grooves as well at the bottom face of the beam and at the optional hole or slot into the slab portion, and said form work can be any of the embodiments described herein. In addition, for the case where the optional hole continues to the opposite face of the slab, placing of the grout may be achieved by pouring into the hole and down the sealed groove. Likewise, insulation may still be preferred (or even necessary) to maintain the reinforcing elements 200 below their maximum operating temperature. The same insulations systems can be used to protect the shear face as well as the underside of the slab on the beam or t-section of a t-beam as used for the flexural systems.

### EXAMPLES

The invention will now be described with reference to the following non-limiting examples, in which all parts and percentages are by weight unless otherwise indicated.

### Example 1

Fiber reinforced polymer reinforcing elements were produced with high tensile strength carbon fiber tows and an epoxy resin with a high transition temperature as the matrix. The reinforcing elements were made in a pultrusion process with an anhydride-cure epoxy resin with a high temperature cure to form a composite rod of carbon fiber in a resin matrix. Representative samples were cut from the composite rods for Dynamic Mechanical Analysis measurements tested according to ASTM D5023-01 to determine the glass transition temperature (T_{g}) of the resin matrix. Samples were machined to 60 mm by 1.5 mm by 5 mm and tested in 3 point bend at 3° C. / min. The tan delta peak measurement was used to determine the T_{g} of the matrix with representative samples measuring 237.2° C., 236.1° C., and 235.0° C. The transition temperature of the matrix in Example 1 far exceeds the typical transition temperature range (70° C. to 85° C.) for composite rods formed with ambient temperature cured epoxies.

### Example 2

Surface modifications to the fiber reinforced polymer reinforcing elements can improve mechanical bonding with the binder. During the pultrusion process, a peel-ply fabric was wound around the outside of the fiber matrix composite to create spiral grooves in the rods after removal of the peel-ply fabric, such as shown in FIGS. 3 and 4. A representative sample was made by pultrusion and tested for tensile strength, as a round reinforcing element with 5/16 inch diameter and spiral grooves averaging 30 grooves per foot. Samples of the reinforcing element were prepared for tensile testing and tested per ASTM D7205. The reinforcing elements were cut to 46″ lengths with each end embedded into a 1″ diameter schedule 80 steel tube, 14 inches in length. An expanding, quick-setting grout was poured into each steel tube to anchor the reinforcing elements. Resulting tensile data of 10 samples showed an average fiber rupture load of 21,584 lbs with a standard deviation of 467 lbs, and an average peak strain of 1.4%.

### Examples 3-6

Inorganic binders were evaluated for use in the fiber reinforced strengthening system. To test the binders, ⅝ inch by ⅝ inch by 6 inch long grooves were cut in 4 inch by 4 inch by 6 inch concrete specimens (made using a pre-blended concrete mix with at least 5000 psi compressive strength). The inorganic binders were prepared by troweling or pouring the inorganic binder into the grooves to anchor a threaded steel rod (⅜-16 3A). Samples were allowed to cure for at least 7 days before testing. A rod pull-out test was performed on samples at room temperature and samples heated to 250° C.

Example 3 used an inorganic, incombustible binder with a thick consistency amenable to troweling into a groove. Samples were prepared and tested for rod pull-out strength at room temperature and at the elevated temperature of 250° C. The average pull-out strength at room temperature was measured at 4778 lbs and the average pull-out strength at 250° C. was 4053 lbs. The heated samples demonstrated more than 80% retention of the room temperature pull-out strength.

Example 4 used an inorganic, incombustible binder with a fluid consistency amenable to pumping into a groove. Samples were prepared and tested for rod pull-out strength at room temperature and at the elevated temperature of 250° C. The average pull-out strength at room temperature was measured at 3814 lbs and the average pull-out strength at 250° C. was 3611 lbs. The heated samples demonstrated more than 90% retention of the room temperature pull-out strength.

Example 5 used a flowable repair grout troweled into the groove. Samples were prepared and tested for rod pull-out strength at room temperature and at the elevated temperature of 250° C. The average pull-out strength at room temperature was measured at 3253 lbs and the average pull-out strength at 250° C. was 1634 lbs. The heated samples demonstrated only about 50% retention of the room temperature pull-out strength, which may not be suitable strength retention to work as a high temperature binder.

Example 6 used an fluid repair grout poured into the groove. Samples were prepared and tested for rod pull-out strength at room temperature and at the elevated temperature of 250° C. The average pull-out strength at room temperature was measured at 3310 lbs and the average pull-out strength at 250° C. was 1516 lbs. The heated samples demonstrated less than 50% retention of the room temperature pull-out strength, which may not be suitable strength retention to work as a high temperature binder.

### Examples 7-8

To test the fiber reinforced strengthening system in a concrete member, large reinforced concrete slabs were poured and cured. The slabs measured 13 feet in length, 6 inch in thickness, and 2 feet in width. Grade 60 steel (with design tensile strength of 60 ksi per ASTM A706) was placed near the bottom of the slab (tension zone) with ¾ inch clear cover bottom, sides, and ends—five longitudinal #4 steel rebars at 5 inch spacing and thirteen transverse #3 steel rebars at 12″ spacing spacing. A welded wire steel mesh (WWR G75) was placed near the top of the slab (compression zone).The design compression strength of the concrete was 4000 psi.

Example 7 was a control reinforced concrete slab loaded in a 4-point loading configuration with a 2 foot loading setup and a 12 foot span tested at room temperature. The steel in the slab began to yield at approximately 8900 lbs load and approximately 1.3 inches measured deflection, and the ultimate load in the yielding region was 11,032 lbs at approximately 4.7 inches measured deflection.

Example 8 was a reinforced concrete slab strengthened with a fiber reinforced polymer strengthening system by adding three longitudinal reinforcing elements at the center of the slab and 7 inches to both sides of center. The reinforcing elements were round bars at 5/16 inch diameter with approximately 30 grooves per foot, similar to those described in Example 2. Grooves were cut into the bottom face of the concrete slab with a ½ inch width by ⅝ inch depth and 10 feet in length. The reinforcing elements were cut to 9.5 feet in length and placed in the grooves. An inorganic binder, similar to Example 4, was pumped into the grooves to anchor the reinforcing elements in the concrete slab. The fiber reinforced strengthened concrete slab was loaded in a 4-point loading configuration identical to the control slab, Example 7, at room temperature. The steel in the slab began to yield at a strengthened load of approximately 11,175 lbs and approximately 1.4 inches measured deflection. The ultimate load of the strengthened slab in the yielding region reached 18,633 lbs at approximately 4.8 inches measured deflection. At the ultimate load the reinforcing elements ruptured. The total strengthening of the concrete slab in Example 8 exceeded the unstrengthened control slab in Example 7 by more than 60%.

### Example 9

A full-scale fire test was performed per ASTM E119 on a large reinforced concrete slab with dimensions 12 feet and 10 inches wide by 18 feet long by 6 inches thick. The reinforced slab contained steel rebar (#4 A706 G60), installed at 10 inch on center in both directions and at the top and bottom of the slab with ¾ inch concrete cover. Normal weight 3000 psi concrete was specified for the slab. The slab was strengthened similar to Example 8 with round carbon rod reinforcing elements with a high transition temperature matrix, similar to Example 1. The reinforcing elements were ⅜″ diameter rods with 15 grooves per foot made in a peel-ply pultrusion process. Grooves were cut at ⅝ inch width by ⅝ inch depth along the 13 foot length direction at 20 inch spacing between steel rebars. The reinforcing elements were placed in the grooves and then an inorganic binder similar to that described in Example 4 was pumped into the grooves to anchor the reinforcing elements to the concrete slab.

After placement of the binder, an insulation system was installed to further protect the reinforcing elements during the fire test. A ceramic based blanket at ½ inch thickness and 6 lbs per cubic foot density, was cut to 12 inches in width and centered over the groove and ran the entire length of each groove. A ceramic fiber based insulation board at 1 inch nominal thickness was placed over the insulation blanket and groove. Each board measured 12 inches width and 36 inches in length. Four boards abutted each other to cover the entire length of each groove. The boards were anchored to the concrete slab with concrete screws and fender washers. The anchoring allowed for some compression of the insulation blanket between the concrete slab and the insulation boards. A ceramic fiber based paste was used to seal along the edges and seams of the board and blanket system.

The slab was supported as a one-way constrained slab during the ASTM E119 fire test. A strengthened service load (calculated per ASTM E119) was applied to the slab and the burners were ignited. Temperature recordings of the reinforcing elements, steel rebar and slab were recorded throughout the test. The strengthened slab supported the strengthened service load throughout the fire test that lasted beyond 3 hours. In addition, the temperatures of the reinforcing elements were measured throughout the test and remained below a predetermined criteria of 205° C. (15° C. below a minimum transition temperature of the matrix of 220° C.) for more than 2 hours.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A fiber reinforced polymer strengthening system comprising:
a concrete or masonry structural member having at least one outer facing surface, wherein the outer facing surface comprises at least one groove;
at least one reinforcing element comprising a roughened surface, a matrix material having a transition temperature of at least about 120° C., and a plurality of fibers, wherein the fibers have a tensile strength of at least about 1000 MPa; and,
a binder comprising an inorganic material, wherein the inorganic material is incombustible, and wherein the at least one reinforcing element and binder are located in at least a portion of the groove in the concrete or masonry structural member such that the binder at least partially covers the reinforcing element.

2. The fiber reinforced polymer strengthening system of claim 1, wherein the fiber reinforced polymer strengthening system further comprises an insulation layer, wherein the insulation layer is adjacent the outer facing surface of the concrete or masonry structural member covering at least a portion of the at least one groove.

3. The fiber reinforced polymer strengthening system of claim 1, wherein the at least one reinforcing element comprises inorganic particles covering at least a portion of the surface of the reinforcing element, wherein the inorganic particles are adhered to the reinforcing element using an adhesive material having a transition temperature of at least about the transition temperature of the matrix material of the reinforcing element.

4. The fiber reinforced polymer strengthening system of claim 1, wherein the at least one reinforcing element comprises a peel-ply reinforcing element.

5. The fiber reinforced polymer strengthening system of claim 1, wherein the at least one reinforcing element comprises additional fibers wrapping the reinforcing element.

6. The fiber reinforced polymer strengthening system of claim 1, wherein the concrete or masonry structural member is selected from the group consisting of a slab, beam, joist, girder, piling, and column.

7. The fiber reinforced polymer strengthening system of claim 1, wherein the fibers are selected from the group consisting of carbon fibers, basalt fibers, glass fibers, aramid fibers, and mixtures thereof.

8. The fiber reinforced polymer strengthening system of claim 1, wherein the matrix material in the at least one reinforcing element is selected from the group consisting of epoxy, anhydride-cured epoxy, cyanate ester, phenolic, and epoxy novolacs.

9. The fiber reinforced polymer strengthening system of claim 1, wherein the binder comprises cementitious material.

10. A structure comprising the fiber reinforced polymer strengthening system of claim 1, wherein the structure is selected from the group consisting of building, bridge, pipe, pier, culvert, and tunnel.

11. The fiber reinforced polymer strengthening system of claim 1, further comprising at least one spring, wherein the at least one spring is located in at least one groove, wherein the spring at least partially surrounds the reinforcing element.

12. A two-way fiber reinforced polymer strengthening system comprising:
a concrete or masonry structural member having at least one outer facing surface, wherein the outer facing surface comprises at least two grooves, wherein the grooves cross at least one intersection;
a plurality of reinforcing elements, each comprising a matrix material having a transition temperature of at least about 120° C. and a plurality of fibers having a tensile strength of at least about 1000 MPa; and,
a binder comprising an inorganic material wherein the inorganic material is incombustible,
wherein at least a portion of each groove contains at least one reinforcing element and binder.

13. The two-way fiber reinforced polymer strengthening system of claim 12, wherein the fiber reinforced polymer strengthening system further comprises an insulation layer, wherein the insulation layer is adjacent the outer facing surface of the concrete or masonry structural member covering at least a portion of the at least one groove.

14. The two-way fiber reinforced polymer strengthening system of claim 12, wherein the at least one reinforcing element comprises inorganic particles covering at least a portion of the surface of the reinforcing element, wherein the inorganic particles are adhered to the reinforcing element using an adhesive material having a transition temperature of at least about the transition temperature of the matrix material of the reinforcing element.

15. The two-way fiber reinforced polymer strengthening system of claim 12, wherein the binder comprises cementitious material.

16. A structure comprising the fiber reinforced polymer strengthening system of claim 12, wherein the structure is selected from the group consisting of building, bridge, pipe, pier, culvert, and tunnel.

17. The two-way fiber reinforced polymer strengthening system of claim 12, further comprising at least one spring, wherein the at least one spring is located in at least one groove, wherein the spring at least partially surrounds the reinforcing element.

18. The two-way fiber reinforced polymer strengthening system of claim 12, wherein the grooves form a grid.

19. The two-way fiber reinforced polymer strengthening system of claim 12, wherein the first groove has a different depth than the second groove.

20. The process of forming a fiber reinforced polymer strengthening system comprising:
obtaining a preformed and cured concrete or masonry structural member having at least one outer facing surface;
cutting at least one groove in the outer facing surface of the concrete structure;
placing at least one reinforcing element in the at least one groove, wherein the at least one reinforcing element comprises a matrix material having a transition temperature of at least about 120° C. and a plurality of fibers having a tensile strength of at least about 1000 MPa and adding an uncured binder to the at least one groove, wherein the uncured binder comprises an uncured inorganic material, and wherein the uncured binder at least partially surrounds the at least one reinforcing element; and,
curing the uncured binder forming a binder that is incombustible, forming a fire resistant fiber reinforced polymer strengthening system.

21. The process of claim 20, further comprising the step of attaching an insulation layer to the outer facing surface of the concrete structure, wherein the insulation layer at least partially covers the at least one groove in the concrete structure.

22. A method of providing a fire resistant strengthening system to existing concrete or masonry structural systems comprising:
obtaining an existing concrete or masonry structural system comprising preformed and cured concrete or masonry structural members, each having at least one outer facing surface;
cutting at least one groove in at least a portion of the outer facing surfaces of the concrete structures;
adding at least one reinforcing element and an uncured binder to the groove, wherein the uncured binder comprises an uncured inorganic material, wherein the reinforcing element comprises a matrix material having a transition temperature of at least about 120° C. and a plurality of fibers having a tensile strength of at least about 1000 MPa, and wherein the uncured binder at least partially surrounds the at least one reinforcing element; and,
curing the uncured binder forming a binder that is incombustible, forming a fire resistant fiber reinforced polymer strengthening system.

23. The process of claim 22, further comprising:
Attaching an insulation layer to the outer facing surface of the concrete structure, wherein the insulation layer at least partially covers the plurality of grooves in the concrete structure forming a fire resistant fiber reinforced polymer structural system, wherein the fiber reinforced polymer structural system passes the ASTM E-119 test.
